(19) United States
(12) Patent Application Publication
(10) Pub. No.: US 2011/0216866 A1
(43) Pub. Date: Sep. 8, 2011

(54) Method and apparatus for the production of nuclear fusion

(76) Inventor: Timothy Raymond Pearson, Belvidere, IL (US)

(21) Appl. No.: 12/932,753

(22) Filed: Mar. 5, 2011

Related U.S. Application Data
(60) Provisional application No. 61/339,787, filed on Mar. 8, 2010.

(51) Int. Cl. G21B 1/00; G21B 1/17; G21B 1/19

(52) U.S. Cl. 376/117; 376/108; 376/119

(57) ABSTRACT

By firing ionized reactant particles into a solid block of reactant, fusion reactions occur. As these particles are fired longitudinally into a thin sheet of reactant, fusion products are ejected laterally into a series of charged collectors. Unfused reactant ions that prematurely exit the solid reactant are recirculated by electric fields within the invention, boosting efficiency. Through the use of several collectors, charged particles of many energies are efficiently collected and converted to electric potential. The use of a solid sheet of reactant greatly increases the probability of fusion events taking place. The shape of the sheet acts to isolate the incoming reactant ions from the outgoing fusion products. Fusion products are not generally converted to heat by virtue of the small amount of material present in a typical product trajectory. Singly and together, these improvements act to greatly increase the efficiency of the reactor over prior art.

### CROSS-REFERENCE TO RELATED APPLICATIONS

I claim priority of Provisional Patent Application No. 61/339,787, filing date Mar. 8, 2010, “Method and Apparatus for the Production of Nuclear Fusion.”

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

Without limiting the scope of the invention, its background will be discussed within the framework of general nuclear fusion. Nuclear fusion is a highly desirable process, as it is capable of releasing significant amounts of energy and subatomic particles from the two reactants provided to it. These fusion products, such as neutrons, can be readily utilized for nuclear experiments and other scientific applications. Additionally, certain reactants release large amounts of charged particles when fused. These charged particles can be directly converted into electrical energy with the appropriate collection structures. One of the largest problems with existing fusion devices is their overall efficiency in terms of power supplied to the reactor versus power extracted in any form, and this low efficiency is what the present invention attempts to improve. Additionally, the prior art is incapable of utilizing the known highly desirable aneutronic fusion reactions, such as that between protons and boron-11, as reported in “Potentiality of the Proton-Boron Fuel for Controlled Thermonuclear Fusion” by Didier C. Moreau in 1976. By contrast, the present invention preferably utilizes the proton-boron-11 reaction to generate electrical power.

The vast majority of nuclear fusion devices in existence and under study at this time rely on direct thermal excitation of the gaseous reactants to overcome the nuclear Columb barrier between the reactant ions. This class of device has a number of drawbacks and limitations, including but not limited to: extreme difficulty of reaction containment, inability to utilize solid reactants efficiently, and general radiative and Bremsstrahlung energy loss prohibiting the use of known desirable aneutronic fusion reactions. The Stellarator, Tokamak, focus fusion, and any other globally hot fusion devices fall into this classification.

Several devices exist that do not rely on direct thermal excitation. These are known as globally cold, locally hot fusion devices, and the present invention belongs to this category. One of the first devices of this class was the so-called “Farnsworth Fusor,” U.S. Pat. No. 3,386,883. It utilizes a central grid structure to electrostatically contain a charged reactant ion gas, into which reactant ions are fired at fusion energies. Unfortunately, it suffers from an abysmal efficiency due to grid collisions, a relative scarcity of fusion events, and no direct way to convert the released energy into electricity.

The closest prior art to the present invention is pyroelectric fusion. A recent example of this type of fusion is a paper by B. Naranjo, J. K. Gimzewski, and S. Putterman entitled “Observation of nuclear fusion driven by a pyroelectric crystal,” published in the March 2005 issue of Nature. In this experiment, deuterium ions were generated by heating a pyroelectric crystal and then accelerating said ions directly into a deuteriated target. However, pyroelectric fusion differs from the present invention in many important aspects, some of which are listed here: means of generating reactant particles, target structure, target angle with respect to the incident reactant beam, absence of reactant recirculation, an inability to use multiple reactants, an inability to refuel the reactor while it is operating, low fusion efficiency, undesirable sputtering of target material on vacuum chamber walls, and an absence of collection elements with which to convert the fusion products to usable electrical power. These limitations apply to the entire class of pyroelectric fusion devices disclosed in the literature, and are overcome in the present invention.

### BRIEF SUMMARY OF THE INVENTION

This invention pertains to a new method and apparatus for the production of nuclear fusion and nuclear fusion byproducts, with applications in power generation, nuclear particle synthesis, and general atomic research.

The invention provides a central scattering block, sandwiched between two thin conductive plates, into which reactants are fired lengthwise at fusion energies. This structure is further placed within a conductive vacuum chamber, and isolated from said chamber by means of insulating supports. A plurality of thin conductive collection elements are suspended from the floor and ceiling of the vacuum chamber in such a way at to capture the majority of charged particles ejected from the scattering block. Each collection element is isolated from the vacuum chamber by means of insulating supports. The combination of the charged collection elements and vacuum chamber walls generates a high electric field that acts to recirculate ejected unfused reactants back into the scattering block, dramatically improving fusion efficiency.

On one wall of the vacuum chamber a standard ion gun is installed to provide a source for the fusion reactant ions. Also connected to the vacuum chamber is a standard vacuum pump and pressure regulation apparatus to maintain the chamber pressure at a level conducive to nuclear fusion.

The central scattering block is comprised of an insulating frame, onto which the conductive plates are affixed on the top and on the bottom. Filtered ports are provided in the insulating frame to allow outside air pressure to force solid or powdered reactants into the device while it is operating.

The vacuum chamber provides a plurality of insulated electrical ports, to allow external circuitry to electrically connect with the scattering block and the collection elements. Additionally, a plurality of valves are provided to allow for refueling of the invention while it is operating.

Electrical devices are provided outside the vacuum chamber to generate the ion acceleration voltages; to monitor voltages, pressures, and radiation within the device; and to down-convert the output voltage to levels more suitable for common use. These electrical devices may be electrically or optically connected to the various elements within the vacuum chamber. Additionally, a computerized control system and user interface are provided to allow for local and remote monitoring and to control the entire invention. Such a control system may optionally interface with a plurality of internal and external sensing devices, including but not limited to radiation, pressure, temperature, voltage, and current sensing devices as are well known in the art.

At least one reactant storage element is provided outside of the vacuum chamber, connected to said chamber by means of a valve that controls the rate of reactant entry.

Without limiting the scope of the invention, several problems in the prior art and their solution in this invention are discussed herein. With respect to the problem of low efficiency, several advancements are made. The present invention first increases the number of fusion events that occur during the initial critical moments of a reactant ion's flight by firing said reactant ion into a solid block of reactant. This decreases loss due to Bremsstrahlung and related effects that would normally occur as prematurely ejected reactant ions are subsequently redirected back into the reaction area of the device, usually many thousands of times. The present invention also increases efficiency by providing two distinct areas of particle flow, each area consisting of particles of similar energy traveling along largely the same trajectories, so as to avoid unwanted interaction between particles and related energy loss. Also, any prematurely ejected, unfused particles are recirculated several times by the electric fields present around the solid reactant, and the small vertical dimension of the solid form reactant allows released fusion products to escape the solid reactant with very low loss. This recirculation is possible because the minimum likely energy of the fusion products is much greater than the maximum possible energy of the reactant ions, and therefore the reactant ions can be electrostatically confined to an area near the solid reactant.

Referring to the problem of collection of electrical energy, a key advancement follows from the novel structure of the invention. As charged particles are ejected from the solid form reactant, they are decelerated by a series of parallel, charged, thin conductive plates in order to convert the kinetic energy of each charged particle into electric potential energy. The charged particles may have a kinetic energy and trajectory that is essentially random, within limits set by the exact fusion reaction taking place. The present invention allows for a low energy particle to be collected via the plate closest to the solid reactant, while high energy particles are collected by the plates farthest from the solid reactant, after having first passed through any intervening plates. In this manner, each plate maintains a voltage proportional to its distance from the solid reactant, which can then be converted to a lower voltage and summed across all plates into a single output voltage.

Finally, it follows from the above improvements to efficiency that the previously unusable, but highly desirable, known aneutronic fusion reactions are now viable as a source of energy. Special attention is drawn to the fusion reaction between protons and solid boron-11 fuel. This reaction produces copious quantities of charged particles, which may be converted directly into electrical power via the methods previously described, while releasing no neutrons or other radioactive substances. This solves another problem present in much of the prior art, specifically high neutron flux and subsequent radioactivity of all materials in and around the fusion reactor. Additionally, unlike much of the prior art, the principal reactants are highly abundant in nature, and should therefore provide a source of fuel well into the foreseeable future.

### BRIEF DESCRIPTION OF THE SEVERAL VIEWS OF THE DRAWING

FIG. 1 is a plan view of the preferred embodiment of the device.

FIG. 2 is a sectional view of the preferred embodiment of the device, along section line A shown in FIG. 1.

FIG. 3 is an exploded view of the preferred embodiment of the device, with the vacuum chamber hidden.

FIG. 4 highlights the preferred structure of a single scattering block.

FIG. 5 is an exploded view of the preferred structure of a single scattering block.

FIG. 6 highlights an alternative structure of a single scattering block.

FIG. 7 is an exploded view of an alternative structure of a single scattering block.

FIG. 8 is a sectional view of an alternative embodiment utilizing multiple scattering blocks.

FIG. 9 is an electrical schematic of an example gas discharge relaxation oscillator.

FIG. 10 is an electrical schematic of an example optically coupled voltage sensor.

FIG. 11 is an electrical schematic of the preferred embodiment of the invention.

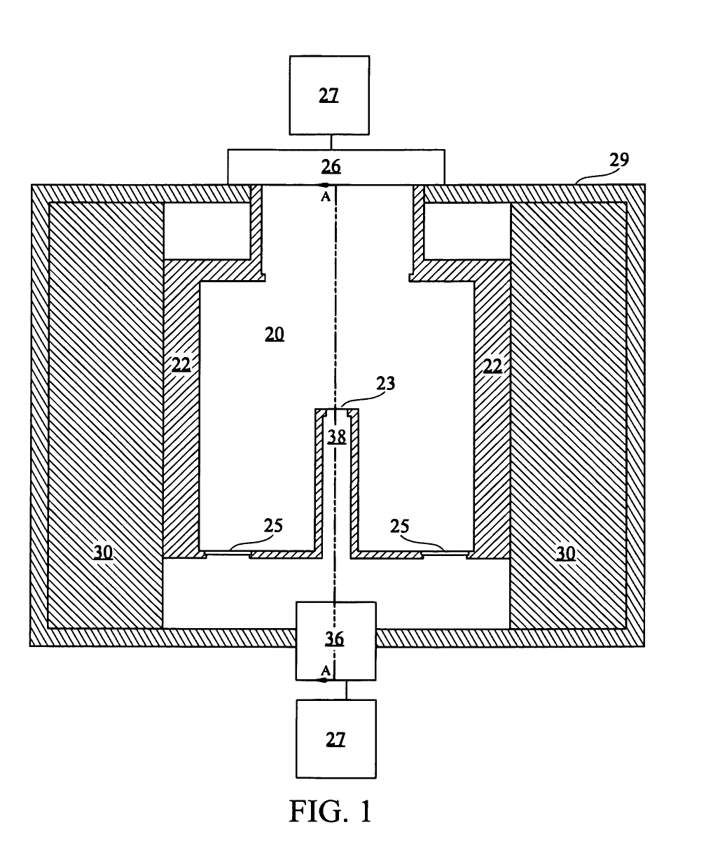

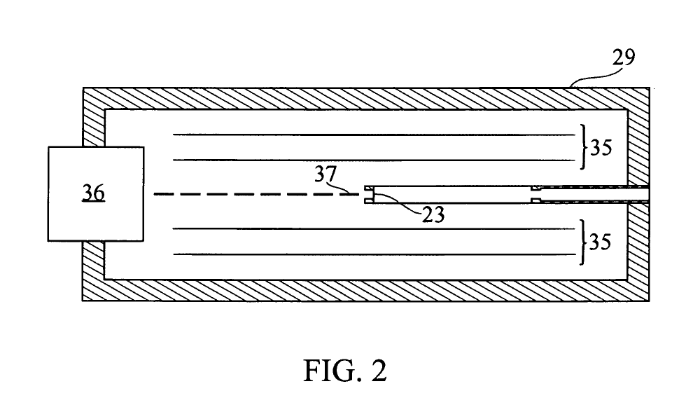

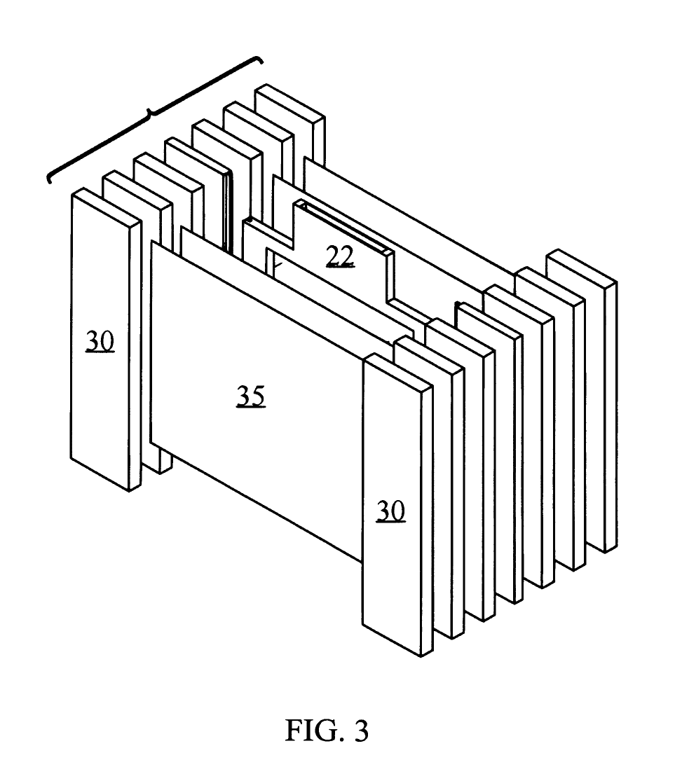

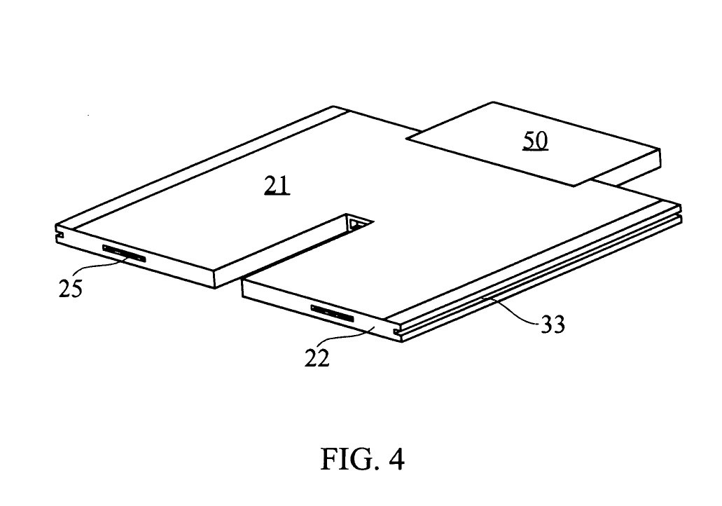

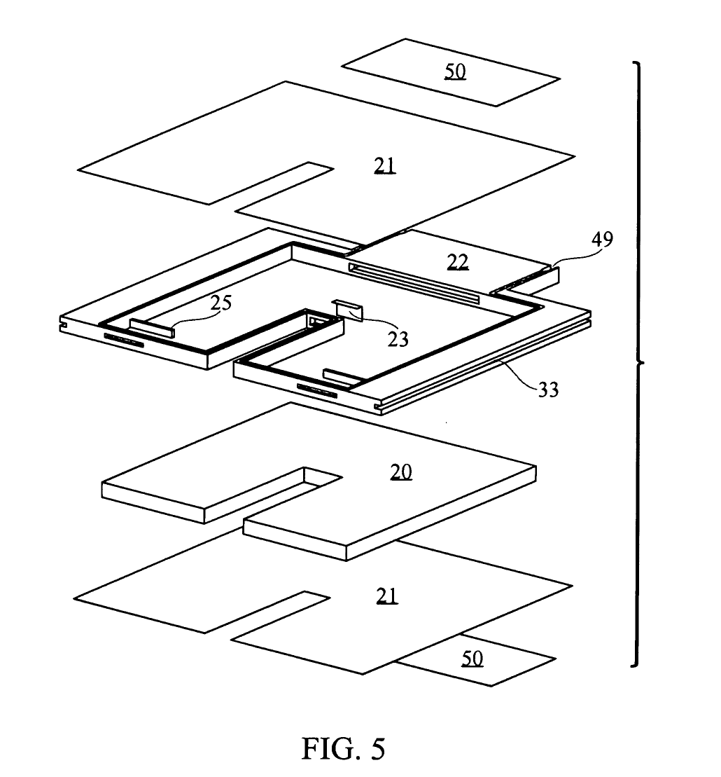

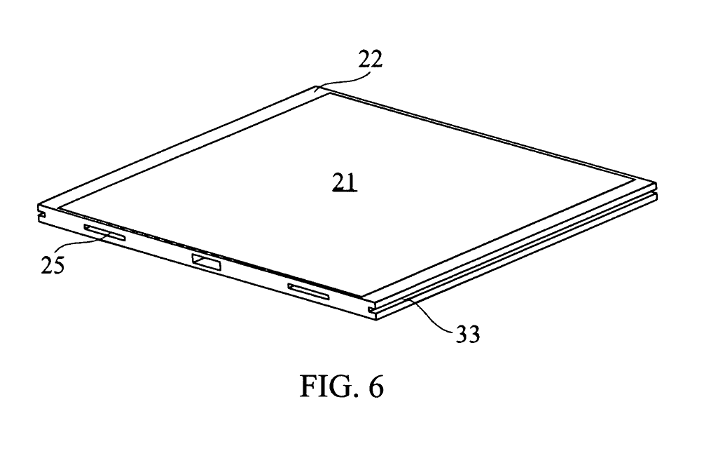

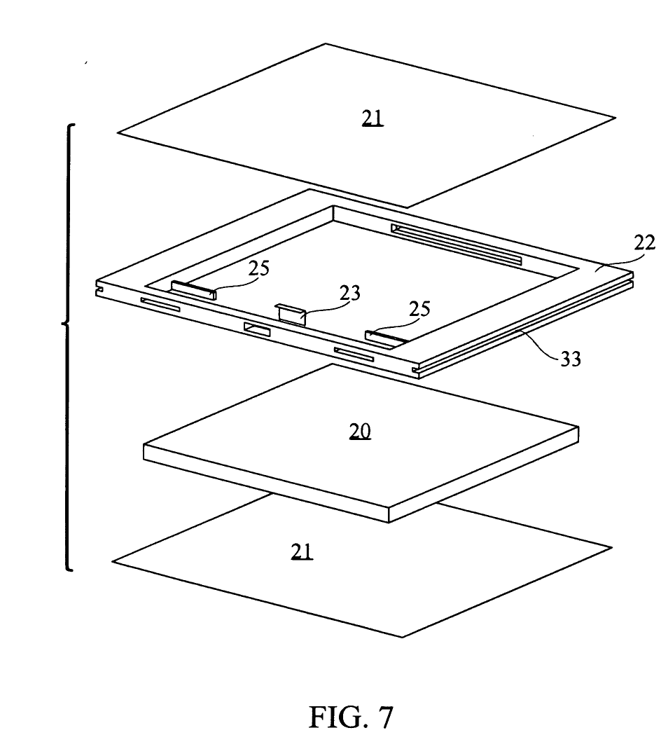

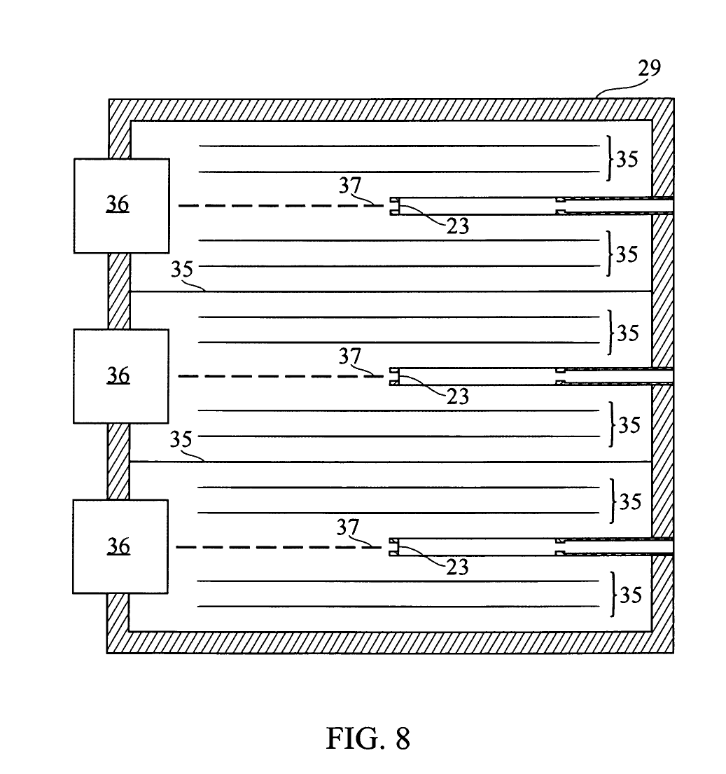

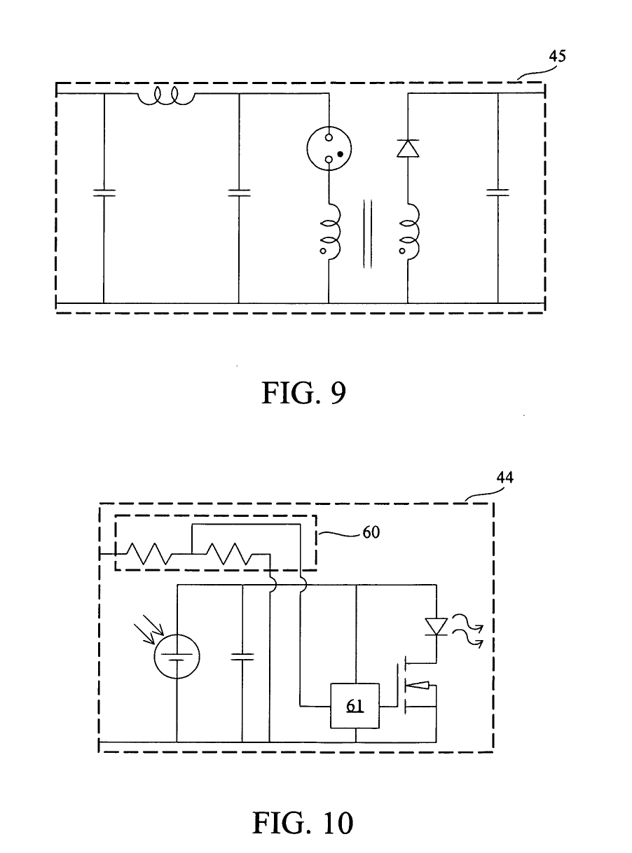

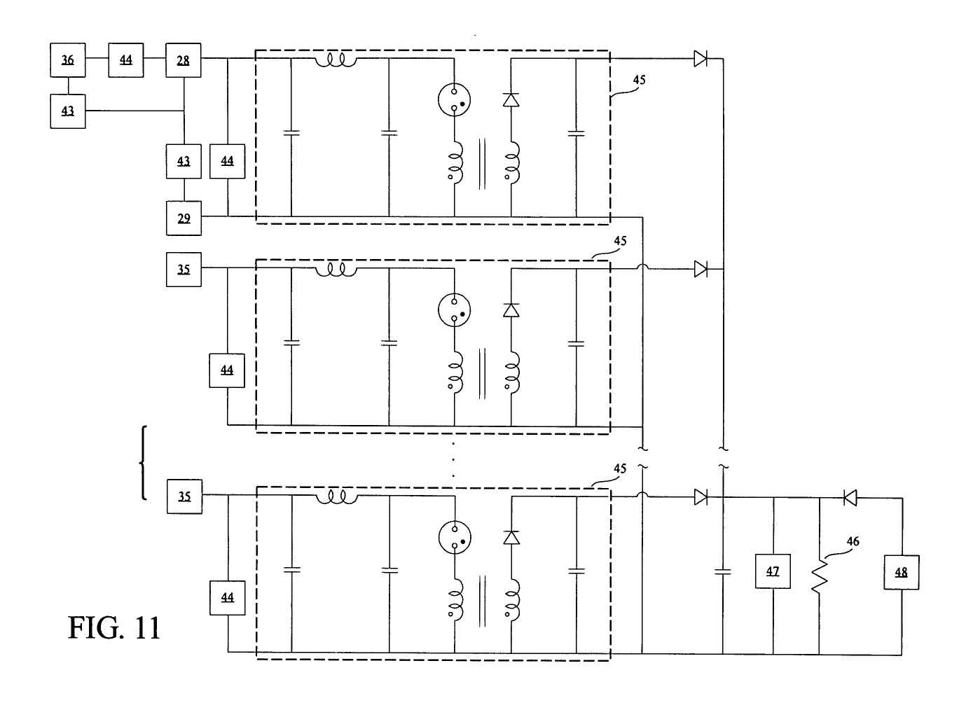

### DETAILED DESCRIPTION OF THE INVENTION

While the design and usage of specific embodiments are discussed below, it should be understood that these discussions do not limit the scope of this invention, and that the broad concepts which are part of this invention may be usable in other specific embodiments which are not discussed below.

The solid state fusion device of the present invention includes a rectangular region of solid or powdered form reactant 20, into which ionic form reactant is fired longitudinally at fusion energies. Preferably this region will have a height much less than its width or depth. In one embodiment this region is placed between two thin conductive plates 21, and an insulating frame 22 is provided to separate the plates and allow solid form fuel to be contained within the resultant structure. A thin conductive window 23, electrically connected to the two conductive plates, is then provided in the insulating frame. Additionally, a plurality of filtered ports are provided in the insulating frame. Each filtered port consists of an opening in the insulating frame into which solid filtering material 25 is inserted. Each filter allows any gaseous substances to pass freely, but blocks passage of all solid or powdered materials in a manner well known to the art. Optionally, an opening or openings are provided in the insulating frame, connected through a valve 26 to an external reactant reservoir 27, whose contents may be held at a pressure higher than the that present inside the cavity. The valve and reservoir are of standard design and operation as is well known in the art. In an alternative embodiment this region is formed from a single solid conductive block of reactant, and no conductive plates or insulating frame are utilized. In another alternative embodiment, this region is comprised of a porous conductive structure into which a reactant or reactants are absorbed. In all embodiments the resulting structure is considered a single entity and referred to as a “scattering block”.

The scattering block 28 is placed within a vacuum chamber 29 and the pressure inside this chamber is reduced to a near total vacuum. This acts to eliminate the majority of collisions between reactant ions in motion at or above fusion energies and any remaining neutral gas atoms. Provided within this vacuum chamber are insulating structures 30 to support the scattering block, collectors, reactant ion source, and internal electrical connections. The walls of this vacuum chamber are preferably substantially parallel to the longitudinal axes of the scattering block. In one embodiment of the invention, the vacuum chamber is comprised of a top and bottom conductive, rectangular plate and four conductive walls, forming a sealed, conductive, hollow box. In a preferred embodiment of the invention, the scattering block is provided with slots 33 which mate with corresponding rails on the insulating structures within the vacuum chamber. In alternative embodiments of the invention, the scattering block may be rigidly mounted or attached without the use of rails, for example with bolts or rivets.

Also provided within the vacuum chamber are a plurality of thin, conductive plates 35. Ideally, each plate is thin enough to allow nearly undeflected passage of the reaction products through each plate. Each plate is referred to herein as a collector. The collectors provided nearest to the scattering block are placed substantially parallel to the top and bottom faces of the scattering block. Each collector is charged to a potential between that of the scattering block and vacuum chamber walls, with the potential increasing proportionally with the distance between each plate and the scattering block. This serves to efficiently decelerate most charged reaction products that exit the scattering block and acts to convert the reaction products into an electric potential. Additionally, the electric field set up between the scattering block and any substantially parallel conductive structures acts to redirect back into the scattering block any unfused reactants that have exited the scattering block, thus increasing overall efficiency. In an alternative embodiment of the invention, the collectors are comprised of a thin, conductive grid or mesh in place of a thin, conductive plate. In one embodiment of the invention, a plurality of collectors are provided within the vacuum chamber, utilizing the previously described electric potential gradient. Electric potential is thereby generated between the scattering block, each collector, and the vacuum chamber walls. In an alternative embodiment of the invention, no collectors are utilized. Instead, the walls of the vacuum chamber are placed substantially parallel to the scattering block, and electric potential is generated between the scattering block and the vacuum chamber walls.

Provided within the invention is an ion source 36 of standard design and operation, to both ionize a gaseous or solid form reactant and to aid in acceleration of formed ions to fusion energies. The ion source is mechanically connected to the vacuum chamber, and its exit aperture is exposed with no obstruction to at least one vertical side of the scattering block. The exit aperture of this ion source is held to an electric potential at or slightly above the fusion barrier energy in electron volts for the reactants in use with respect to the scattering block. In one embodiment of this invention, the ion exit trajectory 37 of the ion source is placed at an angle substantially parallel and coincident with a longitudinal axis of the scattering block. In an alternative embodiment of this invention, the ion exit trajectory of the ion source is placed at an angle which is substantially parallel with any vector addition of the two longitudinal axes of the scattering block. In another alternative embodiment of this invention, a narrow notch 38 is formed in the scattering block, with a longitudinal axis substantially parallel with any vector addition of the two longitudinal axes of the scattering block. The ion exit trajectory of the ion source is placed at an angle which is substantially parallel to and coincident with the longitudinal axis of the resultant scattering block notch.

Also provided within the invention is a vacuum source and pressure regulator of standard design and operation. In one embodiment of the invention, a plurality of valves 26 are provided in the vacuum chamber, to allow admittance of gaseous and solid form reactants on demand. Each vacuum port connects an external reservoir 27 containing additional reactant to the internal scattering block or ion source in order to allow on-line replenishment of the reactor.

Electrical and optical feed-through ports are provided within the walls of the vacuum chamber to allow for bidirectional power transfer and communication between structures or devices placed within the vacuum chamber and any structures or devices provided outside of the vacuum chamber.

In one embodiment of the invention, a high voltage source 43 of standard design and operation, for example a Cockroft-Walton multiplier, is placed outside the vacuum chamber and electrically connected with the scattering block via an electrical feed-through port. In an alternative embodiment the high voltage source is placed within the vacuum chamber, and low voltage power to the high voltage source is transferred via the electrical feed-through ports. In all embodiments the high voltage source is connected between the vacuum chamber walls and the scattering block, and serves to provide an accelerating and decelerating voltage for the charged reactant and product particles. In one embodiment of the invention which utilizes collectors, the collectors are primed to a working particle deceleration voltage via a plurality of high voltage sources. In an alternative embodiment, also employing collectors, the collectors are left unprimed and are charged by intercepting charged product particles.

Optionally, a plurality of high voltage sensors 44 are electrically connected to the collectors, scattering block, and vacuum chamber walls. In one embodiment of this invention, each sensor receives power optically via fiber optic cables and also transmits data optically via the optical feed-through ports. In an alternative embodiment no optical feed-through ports are provided and low voltage sensor power and data signals are transmitted via the electrical feed-through ports. In all embodiments each sensor consists of a voltage divider network 60 and an analog-to-digital conversion circuit 61.

In one embodiment of this invention, an electrical converter 45 is provided to convert the high voltage, low current DC output of the collectors and scattering block to a low voltage, high current DC or AC output suitable for general use in an electrical load 46, which may include electrical devices present within the invention. Optionally, this low voltage may be further converted to standard 120V 60 Hz AC line current via several conversion methods well known to the art. The high voltage converter may, for example, take the form of a tuned gaseous breakdown tube, capacitor, and step-down high voltage transformer. This forms a type of relaxation oscillator well known in the art. It is also possible that with future advances in solid-state switching technology, a standard buck converter, also well known in the art, may be utilized in place of the gaseous breakdown converter.

In one embodiment of this invention a computerized control system and user interface 47 is provided. This control system monitors the output of all sensors within the invention and adjusts reaction voltages, pressures, and reactant valves to optimize performance given varying external conditions. Additionally, this control system allows local or remote user configuration and monitoring of the invention. In an alternative embodiment of the invention, no central control system is provided and any operational parameters are set with dedicated analog circuitry and external diagnostic and calibration equipment. In all embodiments of the invention an external source of electrical power 48 is provided.

In one embodiment of the invention an external source 48 is the primary source of power to the invention. In an alternate embodiment of the invention, charged fusion products are harvested from the invention and converted to an electric potential via collectors 35. In this embodiment, the external source 48 is only utilized briefly during start up in order to power the control systems and electric potential generators 43 before the reactor becomes electrically self-sustaining.

In an alternative embodiment of this invention, a plurality of scattering blocks, collectors, and ion sources are provided within a vacuum chamber. Each scattering block is paired with one or more ion sources and a single set of collectors. In another alternative embodiment of this invention, a plurality of scattering blocks and ion sources are provided within a vacuum chamber, and the generation of non-electrical fusion products is emphasized.

In one embodiment of the invention, a coolant conduit or conduits 49 are built in to the scattering block frame, and a liquid with high thermal conductivity is forced through said conduits. The liquid conveys heat away from the scattering block to the outside of the vacuum chamber via ports in the chamber walls, where it can be radiated away more effectively into the air surrounding the invention. As an example, transference of heat from liquid to ambient air can be accomplished with a standard radiator and fan. In one embodiment of the invention, the conduits 49 are etched into the scattering block frame, and are sealed with a combination of conductive plates 21 and insulating plates 50. The operation of a preferred embodiment of the design will now be discussed. This preferred embodiment consists of a single scattering block with insulating frame, conductive plates, filtered ports, and notch. A single ion source is provided, with ion exit trajectories parallel to and coincident with the longitudinal axis of the notch in the scattering block. Additionally, a plurality of collectors are provided parallel with the scattering block, and sensors connected to a central computerized control system are utilized. The reactants are hydrogen and boron-11, the hydrogen being in the form of a gas and the boron-11 being in the form of a fine powder.

Boron powder is first loaded from an external reservoir into the cavity formed by the scattering block, e.g., with external air pressure working against the internal vacuum to compress the boron-11 powder tightly into the cavity. The hydrogen gas is admitted into the ion source, where it is stripped of its electrons and the resulting protons are accelerated at fusion energy into the scattering block. The high energy protons largely pass through the thin, conductive window at the end of the scattering block notch and enter the boron-11 powder. At this point, a large number of scattering and fusion events begin to occur. With each fusion event, three positively charged helium-4 nuclei with a combined energy of 8.7 MeV are generated and largely leave the scattering block through the top and bottom conductive foil with minimal scattering due to the high energy and mass of each particle, as well as the relatively small vertical dimension of the scattering block. A small fraction of the product particles are converted to heat when they leave the fusion site at an angle substantially parallel with any longitudinal axis of the scattering block, however this process by itself does not severely impact overall efficiency.

Once a helium nucleus leaves the scattering block, it begins to decelerate under the influence of the electric fields between the nearest collector and the scattering block, converting its kinetic energy into electric potential energy. If the helium nucleus leaves the scattering block on a sharp angle from vertical, it is likely that its vertical motion will be nearly arrested before it strikes the first collector. The electric potential energy of that helium nucleus would then be absorbed by the first collector and conducted to the high voltage converter outside the vacuum chamber. Conversely, if the helium nucleus leaves the scattering block at a small angle from vertical, its vertical motion will not be arrested by the time it reaches the first collector. Rather, this helium nucleus will likely pass through several collectors with minimal deflection before its vertical motion is arrested to the point where it can be captured and its electric potential energy absorbed by either a collector or the vacuum chamber walls.

Meanwhile, unfused protons continue to diffuse rapidly throughout the scattering block. Many of these protons, due to the small height of the scattering block, will exit the scattering block vertically without fusing to a boron-11 atom. When a proton does exit the scattering block prematurely, it is redirected back into the block by the electric field between the scattering block and the first collector with minimal energy loss.

Eventually, all protons will have either fused or diffused to the point where they are striking the insulating frame of the scattering block. Those that do strike the frame are converted to heat and act to decrease the efficiency of the invention. Therefore, it is advisable to manufacture the scattering block with a large dimension in both longitudinal directions.

As hydrogen and boron-11 powder are depleted, the control system monitors the voltages and output power from the device and adjusts said voltages to maintain operation at peak power. When the boron-11 powder or hydrogen gas inside the vacuum chamber is depleted to the point that output power is compromised, the corresponding reactant valve is opened and the invention is thereby automatically refueled. Additionally, said control system monitors reactant levels in the external reservoirs and also notifies an operator of any exceptional conditions present in the invention. Examples of exceptional conditions are: a reservoir is empty; high voltage has failed; or the vacuum has been compromised.

The present invention increases efficiency over the prior art by largely separating the proton and helium nucleus trajectories. The helium nuclei are largely confined to the vertical space between the nearest collector and the scattering block, whereas the protons have highest flux between the ion source and the scattering block and also within the scattering block.

Additionally, efficiency is increased by highly unidirectional particle flow. All helium nuclei follow trajectories away from the scattering block, and the majority of proton trajectories are directed away from the ion source. This is largely due to a peculiarity in the fusion process, specifically that those protons fused are the protons that would have been scattered at large angles by the boron-11 nuclei back toward the ion source. For this reason, it is important to utilize a highly pure boron-11 powder within the scattering block, to minimize proton backscatter and resultant efficiency loss.

Sputtering of the target material onto the vacuum chamber walls and insulators is minimized due to the containment effects of the insulating frame and conductive plates that comprise the scattering block in this embodiment. The plates and frame act to trap the relatively low-energy sputtered atoms inside the scattering block, where they will not cause significant detriment to the operation of the invention.

The randomness of the fusion products' energy level and exit trajectory is compensated by the plurality of collection elements present within the chamber. This collector array acts to capture particles of almost any energy level at which the fusion products can exist and converts them to useful electrical power with the aid of the external, high-voltage down-converters.

Additionally, efficiency is increased by the rapid purging of unfused reactants from the vacuum chamber. As an unfused proton's velocity slows through collisions between it and the insulating frame or conductive plates, it is slowed even more rapidly by the increasing collision cross-section with those obstacles. Eventually, the proton recombines with an electron to form a hydrogen atom, and the now neutral atom is swept from the chamber by the vacuum source.

The overall efficiency of the preferred embodiment can be easily described using the following mathematical equation:

E=E_{fusion}E_{scatter}E_{edge}E_{angle}

where E is the overall efficiency, E_{fusion} is the fusion reaction efficiency in terms of energy present in reactants versus energy present in products, E_{scatter} is the efficiency of the scattering block in terms of particles fused versus particles lost as heat, E_{edge} is the efficiency taking only edge effects into consideration, and E_{angle} is the efficiency taking only the product particle launch angle into account. E_{angle} is simple to derive:

$${E}_{angle} = \frac{2 α}{π}$$

where α is the maximum capturable angle in radians with respect to the vertical axis of the scattering block. E_{edge} is more complex, being a function of the scattering block dimensions, and is presented below in two-dimensional form:

$${E}_{edge} = \frac{{\int }_{- w}^{w} 2 a tan ( \frac{w + x}{h} ) + 2 a tan ( \frac{w - x}{h} ) d x}{{\int }_{- w}^{w} 2 π d x}$$

where w is the scattering block width and h is the scattering block height.
While this equation is presented in two-dimensional form, extension to three dimensions is possible. However, the two-dimensional form will be able to provide a reasonably accurate efficiency estimate for general design purposes.

Unfortunately, there is no general mathematical expression that can be derived for E_{scatter}. Additionally, this efficiency can vary widely due to differing scattering properties between specific reactant combinations. Therefore, a proprietary numerical simulator which takes all relevant factors into account has been developed to assist with this portion of the design process.

The efficiency, or power gain, of the fusion reaction between two reactants and expressed as E_{fusion} is well known in the art and will not be repeated here, as it is specific to the particular reactants used and not specific to the present invention.

What I claim:

1. A device for generating nuclear fusion and nuclear fusion products consisting of:
A central scattering block containing a fusion reactant or reactants in solid or powdered form, and having height much less than length or width
A vacuum chamber into which the scattering block is placed, with said scattering block mounted inside the vacuum chamber via electrically insulating support structures.
An ion source which ionizes a fusion reactant or reactants and accelerates the ions to fusion energies, and is capable of withstanding a large electric potential with respect to the scattering block
A high voltage potential source for acceleration of the reactant ions.

2. The device of claim 1, where a plurality of thin conductive collection plates or grids are placed substantially parallel to the scattering block, each mounted via insulating support structures inside the vacuum chamber.

3. The device of claim 2, where one or more electrical voltage converters are provided to convert the high voltage, low current electrical output from the collection devices into a low voltage, high current output suitable for general use.

4. The device of claim 1, where the ion source projects ions along a trajectory substantially parallel to a vector sum of the longitudinal axes of the scattering block.

5. The device of claim 1, where the scattering block is comprised of a solid conductive fusion reactant with no thin conductive plates or insulating frame provided.

6. The device of claim 1, where the scattering block is comprised of a conductive porous material containing fusion reactants.

7. The device of claim 1, where the scattering block is comprised of a non conductive porous material containing fusion reactants, and thin conductive plates are provided on the top and bottom of this block.

8. The device of claim 1, where a central computerized control system is provided to
Monitor internal and external sensors
Adjust operational parameters in response to these inputs so as to maintain proper operation of the invention
Shut down the invention in the case of a critical fault, including but not limited to excessive internal radiation.
Allow for local and remote monitoring and control of the invention.

9. The device of claim 1, where a plurality of scattering blocks are provided.

10. The device of claim 1, where a plurality of ion sources are provided.

11. The device of claim 1, where one or more vacuum valves are provided in conjunction with external reactant reservoirs, to allow for on-line replenishment of reactants within the vacuum chamber.

12. The device of claim 1, where the scattering block is affixed to the vacuum chamber via the use of meshing rails and slots in the electrically insulating structures.

13. The devices of claim 1, where any external source of electrical power is provided for continuous or intermittent use by the invention.

14. The device of claim 1, where the scattering block is comprised of a single conductive crystal with a known crystal orientation.

15. The device of claim 14, where the scattering block crystal planes are oriented such that reactant ions diffuse quickly and with low loss along the ion injection trajectory.

16. The device of claim 1, where the scattering block is comprised of an insulating frame and two thin conductive plates, one attached to the top of the insulating frame and one attached to the bottom of the insulating frame.

17. The device of claim 1, where the scattering block contains a plurality of holes, each containing a filtering material so as to permit gaseous flow and block transit of solid or powdered material.

18. The device of claim 16, where the scattering block insulating frame includes a channel or channels, and a liquid is pumped through said channels for the purpose of heat removal and dissipation.

19. The device of claim 16, where the scattering block contains a long, narrow notch, devoid of reactant and insulating frame, and a thin conductive window covers the interface to the scattering block at the end of said notch.

20. The device of claim 19, where the ion source projects ions along a trajectory substantially parallel to and coincident with the longitudinal axis of the notch in the scattering block.
